(19) United States
(12) Patent Application Publication
(10) Pub. No.: US 2024/0269967 A1
(43) Pub. Date: Aug. 15, 2024

(54) ADHESIVE FORMULATION FOR PRODUCING PRESSED MATERIAL MOLDED BODIES

(71) Applicant: Lignom Holding S.à r.l., Luxemburg (LU)

(72) Inventor: Herbert MIKOWITSCH, Moedling (AT)

(73) Assignee: Lignom Holding S.à r.l., Luxemburg (LU)

(21) Appl. No.: 18/022,048

(22) PCT Filed: Aug. 17, 2021
(86) PCT No.: PCT/EP2021/072779

§ 371 Date: Feb. 17, 2023

(30) Foreign Application Priority Data
Aug. 18, 2020 (AT) A 50695/2020

(51) Int. Cl. B32B 21/02; B32B 7/12; B32B 21/13; B32B 37/12; B32B 38/00; B32B 38/08

(52) U.S. Cl. CPC B32B 21/02; B32B 7/12; B32B 21/13; B32B 37/1284; B32B 38/08; B32B 2037/1253; B32B 2038/0076; B32B 2260/025; B32B 2260/046; B32B 2305/72; B32B 2363/00

(57) ABSTRACT

A chemically curable, aqueous two-component adhesive formulation for producing pressed material molded bodies, in particular pressed material plates, includes a component A of the adhesive formulation that includes 20 wt. % to 100 wt. % of an aqueous phase of a reactive resin functionalized with functional epoxy groups or a mixture of reactive resins functionalized with functional epoxy groups. A component B of the adhesive formulation includes 30 wt. % to 100 wt. % of an aqueous phase of a curing agent having functional amine groups or a mixture of curing agents having functional amine groups. Additionally, a method for producing pressed material molded bodies, in particular pressed material plates, uses such an adhesive formulation.

The invention relates to a chemically curably, aqueous two-component adhesive formulation for producing pressed material molded bodies, in particular pressed material plates, as well as a method for producing pressed material molded bodies, in particular pressed material plates, by means of continuous or discontinuous pressing of mixtures of the adhesive formulation and chip material and/or fiber material or by pressing layers of the adhesive formulation and chip material plates and/or fiber material plates.

The term pressed material molded body is very generally understood to mean a molded body which is molded to form the pressed material molded body by means of joining materials comprising chip and/or fiber material by curing an admixed adhesive formulation, by applying a pressure force, and possibly by heating. The by far most common application of such molded bodies is in the form of plates. The term pressed material molded body thus also includes, for example, chipboards, in particular wafer boards (also referred to as oriented strand boards; OSB), medium-density (wood) fiberboards (so-called MDF plates), high-density (wood) fiberboards (so-called HDF plates), but also layered and/or laminated plate structures, such as laminated veneer lumber plates.

Hence, the term chip material and/or fiber material comprises very generally materials having fibers, such as wood and/or cellulose fibers, including fibers from recycled paper, other recycling material like sawmill waste or recycled lumber, other naturally occurring fibers, such as straw, bamboo, etc., but also synthetic fibers, for example polyester fibers. Of course, the term chip material and/or fiber material also includes materials comprising mixtures of fibers of different types. In this regard, the chip material and/or fiber material may absolutely have different shapes and degrees of comminution. Thus, the chip material and/or fiber material may already be present fully formed, that is as fiber composite bodies, like, for example, in the aforementioned veneer layer plates. The chip material and/or fiber material may, however, also be provisioned more or less loosely, with different grinding degrees, for example with a relatively low grinding degree as so-called chips, like in the aforementioned chipboards or OSB plates, or also in loose form with a relatively high grinding degree, such as, for example, as digested, so-called wood flour, as, for example, in the aforementioned MDF and HDF plates.

Regardless of the type of the chip material and/or fiber material, the (different) methods for producing pressed material molded bodies have in common that a chip material and/or fiber material provided with an adhesive formulation is pressed into a shape using pressure and possibly heat.

Adhesive formulations for these mentioned applications are generally known, wherein these known adhesive formulations, however, have to be adapted depending on the type of the molded body and/or the plate to be produced, and thus, depending on the respective procedure to be used. To some extent, different procedures even use adhesive formulations that are chemically entirely different. For example, the production of so-called fiberboards predominantly uses urea-formaldehyde resins, so-called UF resins, and, in minor quantities, also isocyanate-based resins, whereas mainly phenol resins are used for joining and/or gluing veneer layers together. This necessity of adapting an adhesive formulation to a particular procedure and/or a product, may have a disadvantageous effect on the efficiency.

The adhesive formulations mainly used nowadays in methods for producing pressed material molded bodies have in common that pollutants are released primarily during the curing process. Examples for such pollutants are, inter alia, formaldehyde and volatile components and decomposition products of isocyanate-based formulations. Although efforts to at least reduce the amount of releasable pollutants in the predominantly used adhesive formulations have already been made, such formulations low in pollutants often entail other problems, in particular in terms of process technology.

For example, when producing pressed material molded pieces, a sufficiently short processing time must be given, in order to be able to perform a method economically. Thus, in the methods mainly used nowadays, the pressing of chip material and/or fiber material and adhesive at high temperatures is carried out. The production of chip and/or fiber plates is typically carried out at temperatures of 200° C. to 250° C. These high temperatures are necessary, mostly in order to also achieve as complete a curing in the core of the pressing mixtures as possible, as a press cake of chip material and/or fiber material, for example, is heated from the sides, and the heat has to be conducted into the inner core. However, with the adhesive formulations, including the variants low in pollutants, used nowadays, these high temperatures often lead to damage to a molded body, for example a tearing of the molded body, and may thus cause a high scrap rate.

The object of the invention was to overcome the shortcomings of the prior art and to provide an adhesive formulation, by means of which as process-safe a production of pressed material bodies as possible while avoiding great scrap rates as well as a low-pollutant procedure can be obtained, and which simultaneously can be used as universally as possible in different production methods for pressed material molded bodies. Moreover, it was the object of the invention to provide a method for producing pressed material molded bodies using such an adhesive formulation.

This object is achieved, on the one hand, by a chemically curably, aqueous two-component adhesive formulation for producing pressed material molded bodies, in particular pressed material plates, by means of continuous or discontinuous pressing of mixtures of the adhesive formulation and chip material and/or fiber material or by pressing layers of the adhesive formulation and fiber material plates.

The chemically curable, aqueous two-component adhesive formulation comprises a first aqueous component A, which contains at least one chemically curable reactive resin. Furthermore, the chemically curable, aqueous two-component adhesive formulation comprises a second aqueous component B, which contains at least one curing agent for the chemically curable reactive resin of component A. The components A and B are provided for forming the chemically curable two-component adhesive formulation by mixture of components A and B. In other words, the curable two-component adhesive formulation is formed by a mixture of the two components A and B and/or the curable two-component adhesive formulation is formed by mixing the two components A and B. Mixing components A and B may preferably take place directly before the application, that is directly before gluing the chip material and/or fiber material and/or before gluing the chip and/or fiber material plates, as will be discussed in more detail below.

Component A comprises 20 wt. % to 100 wt. % of an aqueous phase of a reactive resin functionalized with functional epoxy groups or a mixture of reactive resins functionalized with functional epoxy groups, with a resin content of 30 wt. % to 70 wt. %. Component B comprises 30 wt. % to 100 wt. % of an aqueous phase of a curing agent having functional amine groups or a mixture of curing agents having functional amine groups, with a curing agent content of 30 wt. % to 70 wt. %.

Preferably, component A may comprise 30 wt. % to 100 wt. %, in particular 40 wt. % to 100 wt. %, of the aqueous phase of a reactive resin functionalized with functional epoxy groups or the mixture of reactive resins functionalized with functional epoxy groups. Preferably, the resin content of the aqueous phase of component A may amount to 40 wt. % to 65 wt. %, in particular 40 wt. % to 60 wt. %.

Component B may preferably comprise 35 wt. % to 100 wt. %, in particular 40 wt. % to 100 wt. % of the aqueous phase of the curing agent having functional amine groups or the mixture of curing agents having functional amine groups. Preferably, the aqueous phase of the component B may have a curing agent content of 40 wt. % to 65 wt. %, in particular 40 wt. % to 60 wt. %.

In this regard, the aqueous two-component adhesive formulation consists of 20 wt. % to 80 wt. % of component A and 20 wt. % to 80 wt. % of component B. In other words, the two-component adhesive formulation is formed by mixing 20 wt. % to 80 wt. % of component A with 20 wt. % to 80 wt. % of component B. In particular, the two-component adhesive formulation may consist of 30 wt. % to 70 wt. % of component A and 30 wt. % to 70 wt. % of component B.

An aqueous phase of components A and B is understood to mean, depending on the type of the reactive substances used, that is depending on the reactive resin and curing agent, an aqueous dispersion and/or an aqueous suspension and/or an aqueous emulsion and/or an aqueous solution of said reactive substances. The remainder in wt. %, that is the balance adding up to 100 wt. % of an aqueous phase may, in this regard, be formed at least mainly by water. The aqueous phases of components A and B, however, may also have further constituents, such as, for example, dispersion aids and/or suspension aids and/or stabilizers, emulsifiers, defoamers and the like.

Moreover, components A and B may also comprise other constituents and/or substances and/or additives, such as pigment(s), aside from the mentioned and/or phases. Examples for preferred additives, which component A and/or component B may comprise, are explained in more detail below. In case component A and/or component B comprise further constituents, in particular additives, the person skilled in the art is of course to select a proportion of less than 100 wt. % of and/or phase of reactive resin(s) or curing agent from the given wt. % range for the component concerned (A or B). If component A and/or component B comprise further additives, it is possible that the wt. % ratio of component A to component B is to be adjusted within the framework of the specified wt. % ranges.

The adhesive formulation and/or two-component adhesive formulation may also be referred to as glue formulation, sizing agent and/or also as paste, as it is common in the technical jargon of the relevant technical field. In particular, the two-component adhesive formulation may be intended for producing chipboards, fiberboards, and laminated plate structures, such as laminated veneer lumber plates.

The two-component adhesive formulation with the given features is characterized in that, on the one hand, it can be used without releasing pollutants. As trials have shown, in case of the indicated adhesive formulation, there is particularly no release of formaldehyde and isocyanate when curing the adhesive formulation during the production of the pressed material molded bodies. Thereby, for example when using fiber material based primarily on wood fibers, the release of formaldehyde can be limited and/or reduced, in comparison to conventional adhesive formulations, at least to that amount which is released by the wood fiber material itself. In further consequence, this means advantages with respect to the emission of pollutants during the production of the pressed material molded bodies and/or plates and thus, for example, a significant improvement of the working conditions.

Surprisingly, it has also shown that the specified two-component adhesive formulation in the specified composition is universally applicable in the technical field of producing pressed material molded bodies, without needing essential adjustments. Thus, for example chipboard, MDF, HDF, OSB as well as laminated veneer plates can be produced by means of the two-component adhesive formulation, and/or the respective production methods can be performed by means of the two-component adhesive formulation.

Additionally, it has been shown that when using the two-component adhesive formulation, a temperature during the pressing operation can be reduced significantly compared to the conventional adhesive formulations according to the prior art. For example, in trials, it was possible to reduce a temperature during the pressing operation to about 160° C. or less when using the two-component adhesive formulation for example in the case of producing MDF plates.

This is in comparison to the temperatures of more than 200° C. usually required when using conventional adhesive formulations. Completely generally, this also provides for a reduction of energy costs and thus, also a reduction of production costs.

In this context, the two-component adhesive formulation has also proven advantageous with respect to a scrap-free and/or at least low-scrap production of pressed material molded bodies. Apparently, when using the two-component adhesive formulation, on the one hand, a good heat conduction from the outer regions of, for example, a press cake of fiber material and adhesive formulation is provided, so that, in the course of a pressing operation of such a press cake, sufficiently high core temperatures can be achieved in its core area for as complete a curing as possible. This can be proven by, inter alia, the achievable mechanical properties, such as the mechanical flexural strength and/or transverse tensile strength of molded bodies produced as plates, which properties fall clearly inside and/or above the standardized requirements for a respective plate, for example an MDF or HDF plate. On the other hand, it seems that in the course of a pressing operation, barely any damage occurs in the course of a pressing operation, also due to the relatively low temperatures that are required for as complete a curing as possible of the present adhesive formulation, and hence, scrap caused by damage can be prevented.

In an advancement of the two-component adhesive formulation, the aqueous phase of the reactive resin functionalized with functional epoxy groups or the mixture of reactive resins functionalized with functional epoxy groups of component A may have an epoxy equivalent weight of 200 g/mol to 1500 g/mol.

An amount of functional epoxy groups in the specified range has proven particularly suitable for the curing reaction of the reactive resin of component A by means of the curing agent having functional amine groups of component B. Preferably, the aqueous phase of the reactive resin functionalized with functional epoxy groups or the mixture of reactive resins functionalized with functional epoxy groups of component A may have an epoxy equivalent weight of 450 g/mol to 1100 g/mol.

The aqueous phase of the curing agent having functional amine groups or of the mixture of curing agents having functional amine groups of component B may have an amine hydrogen active equivalent weight of 200 g/mol to 700 g/mol. Preferably, the aqueous phase of the curing agent having functional amine groups or the mixture of curing agents having functional amine groups of component B may have an amine hydrogen active equivalent weight of 250 g/mol to 600 g/mol.

In particular, it may be provided that a ratio of an epoxy equivalent weight of the aqueous phase of the reactive resin functionalized with functional epoxy groups or of the mixture of reactive resins functionalized with functional epoxy groups of component A to an amine hydrogen active equivalent weight of the aqueous phase of the curing agent having functional amine groups or of the mixture of curing agents having functional amine groups of component B is 3:1 to 1:2.

A ratio of the equivalent weights in the specified range has proven advantageous with respect to curing the two-component adhesive formulation in the course of a pressing operation and thus also advantageous with respect to the achievable mechanical properties of the pressed material molded bodies.

As is known per se, the term functionalized resin may be understood to generally mean a chemical substance in which the respective functional groups, in the present case epoxy groups of the reactive resin of component A or amine groups of the curing agent of component B, respectively, are present on an oligomeric or polymeric carrier and/or a hydrocarbon structure in a chemically bonded manner. The type of the carrier may generally be diverse in nature.

Preferably, the reactive resin functionalized with epoxy groups or the mixture of reactive resins functionalized with functional epoxy groups of component A may be selected from a group consisting of functionalized acrylate resins, functionalized styrene acrylate resins, functionalized acrylic acid copolymers and functionalized (meth)acrylate copolymers, functionalized acrylate urethane copolymers and functionalized cationic polyesters.

Depending on the type of the epoxy-functionalized resins and/or polymers used, the aqueous phase of component A may be formed, for example, as an aqueous dispersion, suspension, or emulsion, in particular in the case of cationic systems being used, the aqueous phase of component A may, however, also be formed by an aqueous solution. An example to be mentioned for a suitable aqueous phase of component A is the product Ancarez® AR555 by Evonik Corporation.

The curing agent having functional amine groups or the mixture of curing agents having functional amine groups of component B may be selected from a group consisting of functionalized acrylates, functionalized acrylate polymers, functionalized acrylate copolymers, polyamine adducts, functionalized acrylate urethane copolymers, functionalized styrene acrylate resins and cationic epoxy amine adducts.

By way of example, Anquamine® 728 by Evonik Corporation is mentioned at this point as a suitable aqueous phase of component B.

In a preferred embodiment variant, component A or component B may comprise 0.1 wt. % to 20 wt. % of a polyvalent alcohol or multiple polyvalent alcohols.

By using a polyvalent alcohol or multiple polyvalent alcohols in the specified wt. % range, especially a curing of the two-component adhesive formulation that is premature and/or too quick after mixing the components may be effectively avoided or delayed if needed. A polyvalent alcohol has a reaction-delaying effect in the specified reactive resin(s) and/or curing agent(s) of the two-component adhesive formulation. Thus, the necessary mixing with the chip material and/or fiber material and/or the coating of plates comprising fiber material can be performed without running a great risk of too quick of a curing process. This feature is sensible especially in procedures in which, for example, a mixing of the two-component adhesive formulation with the chip material and/or fiber material is carried out at an increased temperature, for example in a so-called blowline. It has proven particularly useful if component A or component B comprises 1 wt. % to 17 wt. % of a polyvalent alcohol or multiple polyvalent alcohols. The polyvalent alcohols used may be, for example, glycols such as butyldiglycol.

Components A and B may each have a pH value between 7 and 10.

In this context, in case of using a polyvalent alcohol as a reaction delayer, it is sensible to make sure that, when adding the polyvalent alcohol for forming the relevant component, a pH value of the polyvalent alcohol is adjusted to a pH value that at least mostly corresponds to the pH value of the relevant component, for example a pH value between 7 and 10, before it is admixed into the relevant component. By this measure, especially an undesirable flocculation of constituents of component A or component B can be avoided.

In an advancement, component A or component B of the two-component adhesive formulation may comprise 0.2 wt. % to 10 wt. % of an anionic or neutral wax, or a mixture of appropriate waxes.

Thereby, especially gluing chip material and/or fiber material, that is mixing with the fiber material, and/or the coating of chip material and/or fiber material plates can be improved. Preferably, component A or component B of the two-component adhesive formulation may comprise 1 wt. % to 6 wt. % of an anionic or neutral wax, or a mixture of appropriate waxes. A suitable wax and/or wax mixture is, for example, the product Hydrowax A 18 by Sasol.

Alternatively to one or multiple waxes as a constituent of component A or B, it is also possible for a solid wax to be added in the course of gluing the chip material and/or fiber material with the adhesive formulation, as is described in more detail below with reference to the method for producing a pressed material molded body.

In a further embodiment of the two-component adhesive formulation, it may be provided that component A or component B comprises 0.1 wt. % to 50 wt. % of a filler or multiple fillers and/or pigment(s).

A filler and/or a pigment may ultimately influence the mechanical properties and/or a coloration of the pressed material molded body.

Moreover, it may be useful if component A or component B of the two-component adhesive formulation comprises 0.1 wt. % to 12 wt. % of a wetting agent or multiple wetting agents and/or surfactants.

By this feature, particularly an improvement of the handling of the aqueous phases of the components and an improvement of the adhesion properties of the two-component adhesive formulation can be achieved. A suitable wetting agent is, for example, Disperbyk 190 by Byk.

Moreover, it may be provided that component A or component B comprises 0.1 wt. % to 15 wt. % of a defoamer or multiple defoamers.

This feature may have an advantageous effect particularly on the pressing operation in the course of producing pressed material molded bodies, for example in order to avoid bubble formation. Surfynol 420 or Surfynol DF 75 by Evonik Corporation can be mentioned as examples for suitable defoamers.

Component A or component B of the two-component adhesive formulation may additionally comprise 0.1 wt. % to 15 wt. % of a thickener or multiple thickeners.

Rheolate 310 D by Elementis and/or Acrysol RM 8 W by Dow are mentioned as examples for suitable thickeners. Such thickeners allow influencing the rheology and thus especially the processing properties of the two-component adhesive formulation and/or allow adapting these to requirements. In particular, adhesive formulations having a thickener are particularly suitable for producing coatings, for example by means of rolled application.

The object of the invention is also achieved by a first method for producing pressed material molded bodies, in particular pressed material plates.

The method comprises the steps of
providing a chip material and/or fiber material or a chip material and/or fiber material mixture,
providing a chemically curable adhesive formulation,
mixing the chip material and/or fiber material or the chip material and/or fiber material mixture with the adhesive formulation, forming a press cake,
and continuous pressing of the press cake, while curing the adhesive formulation, or producing press cake pieces and discontinuous pressing of the press cake pieces in pressing molds, while curing the adhesive formulation.

It is essential to the method that a chemically curable, aqueous two-component adhesive formulation as described above and defined in the relevant claims is used as the adhesive formulation. In this regard, the press cake or the press cake pieces have a weight proportion of chip material and/or fiber material or chip material and/or fiber material mixture of 77 wt. % to 98.5 wt. % and a weight proportion of adhesive formulation of 1 wt. % to 20 wt. %.

The advantages achievable by such a method with using the specified two-component adhesive formulation have already been explained in the context of the above description of the two-component adhesive formulation. In the method, the two-component adhesive formulation can be formed by combining the two components A and B. A combination and/or mixing of the two components may take place before the step or also during the step of mixing the chip material and/or fiber material and/or the chip material and/or fiber material mixture with the adhesive formulation to form the press cake.

Chip material and/or fiber material is understood to mean a material having fibers, such as wood and/or cellulose fibers, including fibers from recycled paper, other recycling material like sawmill waste or recycled lumber, other naturally occurring fibers, such as straw, bamboo, etc., but also synthetic fibers, such as polyester fibers. The chip material and/or fiber material and/or the chip material and/or fiber material mixture may absolutely have different embodiments, in particular different degrees of comminution. The chip material and/or fiber material and/or the chip material and/or fiber material mixture may be provisioned, for example, with different grinding degrees, for example with a relatively low grinding degree as so-called chips, like in the known chipboards or OSB plates, or with relatively high grinding degree, for example, as digested, so-called wood flour, as, for example, in the known MDF and HDF plates.

In an advancement of the method, it may be provided that, while mixing the chip material and/or fiber material or the chip material and/or fiber material mixture with the adhesive formulation, 0.1 wt. % to 3 wt. % of a solid wax are admixed.

Thereby, especially gluing the chip material and/or fiber material or the chip material and/or fiber material mixture, that is mixing the adhesive formulation with the chip material and/or fiber material or the chip material and/or fiber material mixture can be improved.

Finally, the object of the invention may, however, also be achieved by a further method for producing pressed material plates. The method comprises the steps of
providing a plurality of plates comprising chip material and/or fiber material,
coating at least one surface of the plates intended for bonding with another plate with an adhesive formulation,
layering the coated plates to form a plate layering,
pressing the plate layering in the pressing mold while curing the adhesive formulation.

It is again essential to this further method that a chemically curable, aqueous two-component adhesive formulation as described above and defined in the relevant claims is used as the adhesive formulation. A weight proportion of plates of the plate layering amounts to 80 wt. % to 99 wt. %, and a weight proportion of adhesive formulation of the plate layering amounts to 1 wt. % to 20 wt. %.

In order to better understand the invention, it is explained below in further detail by means of non-limiting exemplary embodiments, and the methods for producing pressed material plates are also explained in further detail by means of figures.

An exemplary composition of a chemically curable, aqueous two-component adhesive formulation within the context of the invention is:

### Component A:

Ancarez® AR555; Evonik Corporation; 45.66 wt. %,
Butyldiglycol; 5 wt. %,
Hydrowax A 18; Sasol; 1 wt. %;

### Component B:

Anquamine® 728; Evonik Corporation; 48.34 wt. %.

In the specified exemplary embodiment, the wt. % proportions of the individual constituents of the two-component adhesive formulation refer to 100 wt. % of the two-component adhesive formulation consisting of component A and component B. In the specified exemplary embodiment, component A accordingly consists of 88.38 wt. % of Ancarez® AR555, 9.68 wt. % of butyldiglycol, and 1.94 wt. % of Hydrowax A 18, based on 100 wt. % of component A. In the specified exemplary embodiment, component B consists of 100 wt. % of Anquamine® 728. In the exemplary embodiment, the two-component adhesive formulation is composed of 51.66 wt. % of component A and 48.34 wt. % of component B.

Ancarez® AR555 is an aqueous phase and/or dispersion of a non-ionic reactive resin functionalized with functional epoxy groups, with a solid content of 55 wt. %, with an epoxy equivalent weight of 550 g/mol.

Anquamine® 728 is an aqueous phase of a curing agent having functional amine groups, with a solid content of about 55 wt. %, with an Amine Hydrogen Active Equivalent Weight (AHEW) of 250 g/mol.

The specified two-component adhesive formulation has generally qualified well and universally for the known methods for producing pressed material molded bodies.

However, the specified two-component adhesive formulation is only to be viewed as an exemplary embodiment and depending on specific requirements of a method for producing pressed material molded bodies, adapted or other formulations and/or formulas may also be used instead of the adhesive formulations indicated above.

Hence, for example the product Ancarez® AR555 may be replaced by and/or mixed with other aqueous phases of a reactive resin functionalized with functional epoxy groups or a mixture of reactive resins functionalized with functional epoxy groups. Preferably, the reactive resin functionalized with epoxy groups or the mixture of reactive resins functionalized with functional epoxy groups of component A may be selected from a group consisting of functionalized acrylate resins, functionalized styrene acrylate resins, functionalized acrylic acid copolymers and functionalized (meth)acrylate copolymers functionalized acrylate urethane copolymers and functionalized cationic polyesters.

Likewise, the product Anquamine® 728 may be replaced by or mixed with other aqueous phases of a curing agent having functional amine groups or a mixture of curing agents having functional amine groups. Preferably, the curing agent having functional amine groups or the mixture of curing agents having functional amine groups of component B may be selected from a group consisting of functionalized acrylates, functionalized acrylate polymers, functionalized acrylate copolymers, polyamine adducts, functionalized acrylate urethane copolymers, functionalized styrene acrylate resins and cationic epoxy amine adducts.

Products similar to those mentioned in the exemplary embodiment are generally known to the person skilled in the art.

The butyldiglycol specified in the exemplary embodiment described above may also possibly be replaced by or mixed with another polyvalent alcohol and/or glycol, or a mixture of polyvalent alcohols. Depending on the type of the production method for a pressed material molded body and/or depending on the procedure, a polyvalent alcohol and/or a mixture of polyvalent alcohols may also be completely done without as a constituent of one of the components A or B. The same also applies to Hydrowax A 18 also mentioned in the exemplary embodiment.

Furthermore, any additives may be admixed to component B instead of component A, as indicated in the above exemplary embodiment for butyldiglycol and Hydrowax A 18.

Depending on the requirements and/or procedure, it may also be useful that component A or component B of the two-component adhesive formulation comprise even more additives than those specified in the above exemplary embodiment, that is butyldiglycol and Hydrowax A 18. For example, component A or component B may comprise, for example, 0.1 wt. % to 50 wt. % of a filler or multiple fillers and/or pigment(s), 0.1 wt. % to 12 wt. % of a wetting agent or multiple wetting agents, 0.1 wt. % to 15 wt. % of a defoamer or multiple defoamers, and/or 0.1 wt. % to 15 wt. % of a thickener or multiple thickeners. Additionally, component A or component B may comprise 0.1 wt. % to 20 wt. % of a polyvalent alcohol or multiple polyvalent alcohols, as well as 0.2 wt. % to 10 wt. % of an anionic or neutral wax.

Depending on the type and number of additives and/or depending on general requirements and the procedure of the method for producing pressed material molded bodies, the wt. % proportions of the constituents of components A and B of the adhesive formulation, that is of the aqueous phases, may naturally be adapted to polyvalent alcohols as well as a variety of additives. In this regard, a respective appropriate adaption of weight proportions of the constituents can be performed by the person skilled in the art within the wt. % ranges stated above for the individual constituents. Of course, the weight proportions of components A and B of the two-component adhesive formulation may also be adapted relative to one another and also accordingly within the stated wt. % ranges.

In particular, component A of the two-component adhesive formulation comprises 20 wt. % to 100 wt. % of an aqueous phase of a reactive resin functionalized with functional epoxy groups or a mixture of reactive resins functionalized with functional epoxy groups, with a resin content of 30 wt. % to 70 wt. %. Furthermore, component B of the two-component adhesive formulation comprises 30 wt. % to 100 wt. % of an aqueous phase of a curing agent having functional amine groups or a mixture of curing agents having functional amine groups, with a curing agent content of 30 wt. % to 70 wt. %. In this regard, the aqueous two-component adhesive formulation consists of 30 wt. % to 70 wt. % of component A and 30 wt. % to 70 wt. % of component B.

The aqueous phase of the reactive resin functionalized with functional epoxy groups or the mixture of reactive resins functionalized with functional epoxy groups of component A may have an epoxy equivalent weight of 200 g/mol to 1500 g/mol. The aqueous phase of the curing agent having functional amine groups or of the mixture of curing agents having functional amine groups of component B may have an amine hydrogen active equivalent weight of 200 g/mol to 700 g/mol. In this regard, a ratio of an epoxy equivalent weight of the aqueous phase of the reactive resin functionalized with functional epoxy groups or of the mixture of reactive resins functionalized with functional epoxy groups of component A to an amine hydrogen active equivalent weight of the aqueous phase of the curing agent having functional amine groups or of the mixture of curing agents having functional amine groups of component B may be 3:1 to 1:2.

Furthermore, components A and B may each have a pH value between 7 and 10.

In the following, exemplary embodiments for methods for producing pressed material plates are described by means of figures. These show in a respectively very simplified schematic representation:

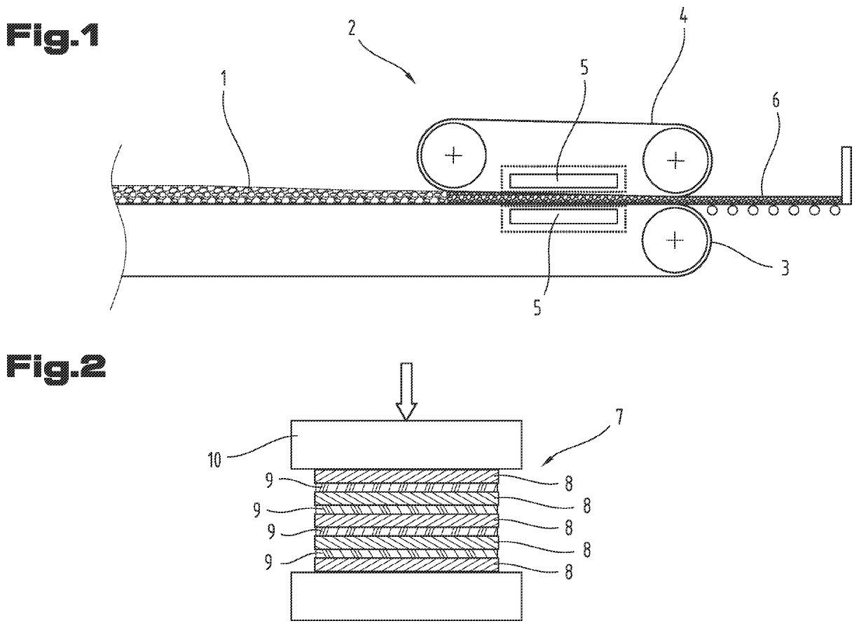

FIG. 1 an exemplary embodiment for a continuous pressing operation of a press cake to form a pressed material plate by means of a double-belt press;

FIG. 2 an exemplary embodiment for a discontinuous pressing operation for a layering of plates comprising fiber material and layers of the two-component adhesive formulation.

A method for producing pressed material molded bodies, in particular pressed material plates, generally comprises the steps of
providing a chip material and/or fiber material or a chip material and/or fiber material mixture,
providing a chemically curable adhesive formulation,
mixing the chip material and/or fiber material or the chip material and/or fiber material mixture with the adhesive formulation, forming a press cake,
continuous pressing of the press cake, while curing the adhesive formulation, or producing press cake pieces and discontinuous pressing of the press cake pieces in pressing molds, while curing the adhesive formulation.

In this regard, a chemically curable, aqueous two-component adhesive formulation as described above and defined in the relevant claims may be used as the adhesive formulation.

Mixing the chip material and/or fiber material or the chip material and/or fiber material mixture with the two-component adhesive formulation, which is also referred to as gluing in technical jargon, may be carried out in different manners, as is known per se. At this point, mechanical gluing and/or mixing in mixing devices, gluing by means of a so-called blowline, and the rarer dry gluing are mentioned as the most common methods. As these gluing and/or mixing methods are known to the person skilled in the art, an elaborate description can be done without at this point. Here, as an alternative to the exemplary embodiment for a two-component adhesive formulation mentioned above, comprising a wax (Hydrowax A 18), it may be provided that, while mixing the chip material and/or fiber material or the chip material and/or fiber material mixture with the adhesive formulation, 0.1 wt. % to 3 wt. % of a solid wax are admixed.

The production of the two-component adhesive formulation by mixing components A and B may take place, for example, prior to mixing with the chip material and/or fiber material or also while mixing with the chip material and/or fiber material.

After and/or by means of mixing the chip material and/or fiber material or the chip material and/or fiber material mixture with the two-component adhesive formulation, a so-called press cake is formed and/or obtained, which is subsequently subjected to pressing.

In FIG. 1, an exemplary embodiment for a continuous pressing operation for a press cake 1 is shown. Such a continuous pressing operation of the press cake 1 may be accomplished by means of a double-belt press 2 like in the exemplary embodiment shown in FIG. 1. The double-belt press 2 shown in the exemplary embodiment according to FIG. 1, has a so-called lower belt 3, on which the press cake 1 is applied and conveyed, as well as an upper belt 4 as a pressing element. The press cake 1 is guided, as illustrated in FIG. 1, between the lower belt 3 and the upper belt 4 of the double-belt press 2 and can be compressed and/or pressed by adjusting the lower belt 3 and the upper belt 4 relative to one another with a respectively desired pressure force. In the course of pressing the press cake 1, the two-component adhesive formulation is also cured, wherein a curing of the two-component adhesive formulation can be initiated and/or accelerated by heating, for example by means of the heating means 5 illustrated in FIG. 1.

FIG. 1 shows merely one possible exemplary embodiment for a continuous pressing of a press cake 1, wherein other, continuously working pressing systems, such as presses having press rollers or combinations of belts and rollers or so-called calenders, as it is known per se and common in this area of producing press cake molded bodies. In case of a continuous pressing, a pressed material strand 6 is obtained, as illustrated in FIG. 1, which strand 6 is subsequently separated into pressed material molded bodies, in particular pressed material plates, by means of cutting.

Alternatively to a continuous pressing, as illustrated, for example, by means of the exemplary embodiment shown in FIG. 1, it is also possible that in the method, press cake pieces previously produced in a targeted manner, which are obtainable, for example, by cutting a continuously delivered press cake, are pressed discontinuously again while curing the two-component adhesive formulation to form a press cake molded body. Such a discontinuous pressing may be carried out, for example, in pressing molds with adjustable press stamps.

Regardless of the embodiment of the method by means of continuous or discontinuous pressing of a press cake and/or press cake piece, the press cake or the press cake pieces have a weight proportion of chip material and/or fiber material or chip material and/or fiber material mixture of 77 wt. % to 98.5 wt. % and a weight proportion of two-component adhesive formulation of 1 wt. % to 20 wt. %.

FIG. 2 shows an exemplary embodiment for an alternative method for producing pressed material molded bodies, in particular pressed material plates, in a greatly simplified and grossly schematic manner, in which method the two-component adhesive formulation according to the invention may also be used.

This alternative method comprises the steps of
providing a plurality of plates comprising chip material and/or fiber material, in particular laminated veneer plates,
coating at least one surface of the plates intended for bonding with another plate with an adhesive formulation,
layering the coated plates to form a plate layering,
pressing the plate layering in the pressing mold while curing the adhesive formulation.

FIG. 2 shows a corresponding plate layering 7, in which plates 8 comprising chip material and/or fiber material and, in each case, one layer of the two-component adhesive formulation 9 arranged between two plates 2 are layered alternatingly. The layering 7 illustrated in a grossly schematic manner in FIG. 7 may be pressed, for example, by means of a press stamp 10, possibly also in a pressing mold not shown in FIG. 2. Coating and/or gluing the plates 8 with the adhesive formulation 9 may take place before pressing, wherein, in principle, either one surface 11 of the plates at a time or also both surfaces 11 of at least the inner plates 8 can be coated with the adhesive formulation 9.

In the procedure by pressing plate layerings 7, illustrated in FIG. 2, it is also possible to use a two-component adhesive formulation 9 as described above as an adhesive formulation, wherein a weight proportion of plates of the plate layering amounts to 80 wt. % to 99 wt. %, and a weight proportion of adhesive formulation of the plate layering amounts to 1 wt. % to 20 wt. %.

The exemplary embodiments show possible embodiment variants, while it should be noted at this point that the invention is not limited to these particular mentioned embodiment variants thereof.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10. Finally, as a matter of form, it should be noted that for ease of understanding of the structure, elements are partially not depicted to scale and/or are enlarged and/or are reduced in size.

### LIST OF REFERENCE NUMBERS

1 Press cake
2 Double belt press
3 Lower belt
4 Upper belt
5 Heating means
6 Pressed material strand
7 Plate layering
8 Plate
9 Adhesive formulation
10 Press stamp

1-16. (canceled)

17: A chemically curable, aqueous two-component adhesive formulation for producing pressed material molded bodies, in particular pressed material plates, by continuously or discontinuously pressing mixtures of the adhesive formulation and chip material and/or fiber material, or by pressing layerings of the adhesive formulation and chip material and/or fiber material, comprising
a first aqueous component A comprising at least one chemically curable reactive resin; and
a second aqueous component B comprising at least one curing agent for the chemically curable reactive resin of component A;
wherein components A and B are provided for forming the chemically curable two-component adhesive formulation by mixing components A and B,
wherein component A comprises 20 wt. % to 100 wt. % of an aqueous phase of a reactive resin functionalized with functional epoxy groups or a mixture of reactive resins functionalized with functional epoxy groups, with a resin content of 30 wt. % to 70 wt. %, and
wherein component B comprises 30 wt. % to 100 wt. % of an aqueous phase of a curing agent having functional amine groups or a mixture of curing agents having functional amine groups, with a curing agent content of 30 wt. % to 70 wt. %,
wherein the aqueous two-component adhesive formulation consists of 20 wt. % to 80 wt. % of component A and 20 wt. % to 80 wt. % of component B,
wherein the aqueous phase of the reactive resin functionalized with functional epoxy groups or the mixture of reactive resins functionalized with functional epoxy groups of component A has an epoxy equivalent weight of 200 g/mol to 1500 g/mol.

18: The adhesive formulation according to claim 17, wherein the aqueous phase of the curing agent having functional amine groups or the mixture of curing agents having functional amine groups of component B has an amine hydrogen active equivalent weight of 200 g/mol to 700 g/mol.

19: The adhesive formulation according to claim 17, wherein a ratio of an epoxy equivalent weight of the aqueous phase of the reactive resin functionalized with functional epoxy groups or of the mixture of reactive resins functionalized with functional epoxy groups of component A to an amine hydrogen active equivalent weight of the aqueous phase of the curing agent having functional amine groups or of the mixture of curing agents having functional amine groups of component B is 3:1 to 1:2.

20: The adhesive formulation according to claim 17, wherein the reactive resin functionalized with epoxy groups or the mixture of reactive resins functionalized with functional epoxy groups of component A are selected from a group consisting of functionalized acrylate resins, functionalized styrene acrylate resins, functionalized acrylic acid copolymers and functionalized (meth)acrylate copolymers, functionalized acrylate urethane copolymers and functionalized cationic polyesters.

21: The adhesive formulation according to claim 17, wherein the curing agent having functional amine groups or the mixture of curing agents having functional amine groups of component B are selected from a group consisting of functionalized acrylates, functionalized acrylate polymers, functionalized acrylate copolymers, polyamine adducts, functionalized acrylate urethane copolymers, functionalized styrene acrylate resins and cationic epoxy amine adducts.

22: The adhesive formulation according to claim 17, wherein component A or component B comprises 0.1 wt. % to 20 wt. % of a polyvalent alcohol or multiple polyvalent alcohols.

23: The adhesive formulation according to claim 17, wherein components A and B each have a pH value between 7 and 10.

24: The adhesive formulation according to claim 17, wherein component A or component B comprises 0.2 wt. % to 10 wt. % of an anionic or neutral wax or a mixture of corresponding waxes.

25: The adhesive formulation according to claim 17, wherein component A or component B comprises 0.1 wt. % to 50 wt. % of a filler or multiple fillers and/or pigment(s).

26: The adhesive formulation according to claim 17, wherein component A or component B comprises 0.1 wt. % to 12 wt. % of a wetting agent or multiple wetting agents.

27: The adhesive formulation according to claim 17, wherein component A or component B comprises 0.1 wt. % to 15 wt. % of a defoamer or multiple defoamers.

28: The adhesive formulation according to claim 17, wherein component A or component B comprises 0.1 wt. % to 15 wt. % of a thickener or multiple thickeners.

29: A method for producing pressed material molded bodies, in particular pressed material plates, comprising the steps of
providing a chip material and/or fiber material or a chip material and/or fiber material mixture,
providing a chemically curable adhesive formulation,
mixing the chip material and/or fiber material or the chip material and/or fiber material mixture with the adhesive formulation, forming a press cake,
continuous pressing of the press cake, while curing the adhesive formulation, or producing press cake pieces and discontinuous pressing of the press cake pieces in pressing molds, while curing the adhesive formulation,
wherein the chemically curable, aqueous two-component adhesive formulation according to claim 17 comprising
a first aqueous component A having at least one chemically curable reactive resin, and
a second aqueous component B having at least one curing agent for the chemically curable reactive resin of component A,
is used as the adhesive formulation,
wherein components A and B are provided for forming the chemically curable two-component adhesive formulation by mixing components A and B,
wherein component A comprises 20 wt. % to 100 wt. % of an aqueous phase of a reactive resin functionalized with functional epoxy groups or a mixture of reactive resins functionalized with functional epoxy groups, with a resin content of 30 wt. % to 70 wt. %, and
wherein component B comprises 30 wt. % to 100 wt. % of an aqueous phase of a curing agent having functional amine groups or a mixture of curing agents having functional amine groups, with a curing agent content of 30 wt. % to 70 wt. %,
wherein the aqueous two-component adhesive formulation comprises 20 wt. % to 80 wt. % of component A and 20 wt. % to 80 wt. % of component B, and
wherein the press cake or the press cake pieces have a weight proportion of chip material and/or fiber material or chip material and/or fiber material mixture of 77 wt. % to 98.5 wt. % and a weight proportion of two-component adhesive formulation of 1 wt. % to 20 wt. %.

30: The method according to claim 29, wherein, while mixing the chip material and/or fiber material or the chip material and/or fiber material mixture with the adhesive formulation, 0.1 wt. % to 3 wt. % of a solid wax are admixed.

31: A method for producing pressed material plates, comprising the steps of
providing a plurality of plates comprising chip material and/or fiber material, coating at least one surface of the plates intended for bonding with another plate with an adhesive formulation,
layering the coated plates to form a plate layering,
pressing the plate layering in the pressing mold while curing the adhesive formulation,
wherein the chemically curable, aqueous two-component adhesive formulation according to claim 17 comprising
a first aqueous component A having at least one chemically curable reactive resin, and
a second aqueous component B having at least one curing agent for the chemically curable reactive resin of component A,
is used as the adhesive formulation,
wherein components A and B are provided for forming the chemically curable two-component adhesive formulation by mixing components A and B,
wherein component A comprises 20 wt. % to 100 wt. % of an aqueous phase of a reactive resin functionalized with functional epoxy groups or a mixture of reactive resins functionalized with functional epoxy groups, with a resin content of 30 wt. % to 70 wt. %, and wherein component B comprises 30 wt. % to 100 wt. % of an aqueous phase of a curing agent having functional amine groups or a mixture of curing agents having functional amine groups, with a curing agent content of 30 wt. % to 70 wt. %,
wherein the aqueous two-component adhesive formulation comprises 20 wt. % to 80 wt. % of component A and 20 wt. % to 80 wt. % of component B, and
wherein a weight proportion of plates of the plate layering amounts to 80 wt. % to 99 wt. %, and a weight proportion of adhesive formulation of the plate layering amounts to 1 wt. % to 20 wt. %.
